(19) United States
(12) Patent Application Publication
(10) Pub. No.: US 2017/0148145 A1
(43) Pub. Date: May 25, 2017

(54) Sharpening Algorithm For Images based on Polar Coordinates

(71) Applicant: GoPro, Inc., San Mateo, CA (US)

(72) Inventor: Scott Patrick Campbell, Belmont, CA (US)

(21) Appl. No.: 15/212,132

(22) Filed: Jul. 15, 2016

Related U.S. Application Data
(60) Provisional application No. 62/259,606, filed on Nov. 24, 2015.

(51) Int. Cl. G06T 5/00; G06T 3/60; G06T 7/00

(52) U.S. Cl. CPC G06T 5/003; G06T 7/0042; G06T 3/604; G06T 2207/10004; G06T 2207/20021

(57) ABSTRACT

A system and method are disclosed that perform sharpening of an image to remove or reduce the noise component in the Euclidian and polar dimensions of the image. A sharpening module receives an unprocessed image. A plurality of sub-images are determined from the received image. For each sub-image, a plurality of pixels of the sub-image are rotated based on a specific rotation angle. A sagittal and a tangential function of the plurality of pixels are determined for a specific radius of the camera lens. A sharpening function is applied to the sagittal and tangential functions of the plurality of pixels of the rotated sub-image. The sharpened sub-image is inverse rotated based on a rotation angle to revert it to its original orientation. The sharpened sub-images are blended at their edges to remove discontinuities between the sub-images.

### CROSS REFERENCE TO RELATED APPLICATION

This application claims the benefit of U.S. Provisional Application No. 62/259,606, filed Nov. 24, 2015, the content of which is incorporated by reference in its entirety.

### TECHNICAL FIELD

This disclosure relates to image sharpening, and more specifically, uniform sharpening of captured images.

### BACKGROUND

Digital cameras are increasingly used in day-to-day activities. Most users of digital cameras are relatively novice photographers and are not well versed with the mechanical/operational/electronic details of the cameras. The users often prefer cameras that provide the best quality of images without having to manually adjust a lot of camera settings. Additionally, users often prefer cameras that are not priced too high. To achieve lower cost, camera manufacturers use cheaper lenses that have average lens quality and thereby reducing image quality.

Reduction of image quality from lower quality lenses may be due to lens imperfections. The imperfections degrade the image quality captured on an image sensor. For example, the captured image may be out of focus or blurred images. Some digital cameras include post processing capabilities that include sharpening of captured images. The process to sharpen an image includes adjusting the image pixels to reduce the blur, thus improving the image quality without upgrading to a better performing lens. To achieve the best results, the image may be sharpened in as many possible dimensions of the camera lens. This may increase resources required for post processing the image. For example, post processing may require camera resources that include greater image processing power, more memory, and / or larger battery capacity to manage the processing needs. These additional resources may increase costs and may increase size when more compact camera forms may be desired.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 illustrates an example environment for image sharpening, according to one example embodiment.

FIG. 2 illustrates the logical components of the image sharpening module, according to one example embodiment.

FIG. 3 illustrates an unprocessed image in a Euclidian plane, according to one example embodiment.

FIG. 4A illustrates the polar co-ordinate plane of the camera lens, according to one example embodiment.

FIG. 4B illustrates a modulation transfer function plot for every radii of a camera lens, according to one example embodiment.

FIG. 5A-5B illustrates an exemplary rotation of a sub-image based on a specific rotation angle, according to one example embodiment.

FIG. 6 illustrates an exemplary rotation matrix, sharpening matrix and an inverse rotation matrix according to one example embodiment.

FIG. 7 illustrates a flowchart of a method for sharpening an image based on polar co-ordinates, according to one example embodiment.

FIG. 8 illustrates an example machine for implementing the sharpening algorithm, according to one example embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

By way of example, the disclosed configuration may include a system that may be configured for sharpening images from a camera. The system receives an image that includes Euclidian plane components and polar components. The Euclidian plane components include dimensional components, for example, pixels in the X-coordinate, Y-coordinate or Z-coordinate. The polar components include radii and angular components, for example, pixels at a specified angle in degrees or radians or at a specific radius. A number of sub-images are determined from the image. The sub-images may be determined based on the Euclidian plane components. The system further receives a specific rotation angular component to align each sub-image.

To align the sub-image based on the specified angular component, the system determines a rotation matrix based on the specific angular component. Each pixel of the sub-image is rotated by multiplying a pixel vector of the sub-image to a vector of the rotation matrix. Further, the system receives a sagittal function and a tangential function. The sagittal function and tangential functions are determined based on a modulation transfer function (MTF) of the lens of the camera. The MTF is a performance function plot of a lens of the camera for a plurality of radii of the lens. The system determines a sharpening function based on a specific radii and the specified rotation angular component to sharpen the sagittal portion of pixels of the sub-image. Further, the system determines a sharpening function based on a specific radii and the specified rotation angular component to sharpen the tangential portion of pixels of the sub-image. The rotated and sharpened pixels of each of the sub-images are further inverse rotated based on an inverse rotation angular component. The sub-images are blended along the edge of the sub-images to sharpen any discontinuities and in the process, obtain a sharpened image.

In addition to a system, the configuration described herein also may be embodied as a method (or process) and may be embodied as a non-transitory computer readable storage medium having stored instructions (or program code) corresponding to the methods and/or functionality and are executable by one or more processors.

### Example Image Sharpening Environment

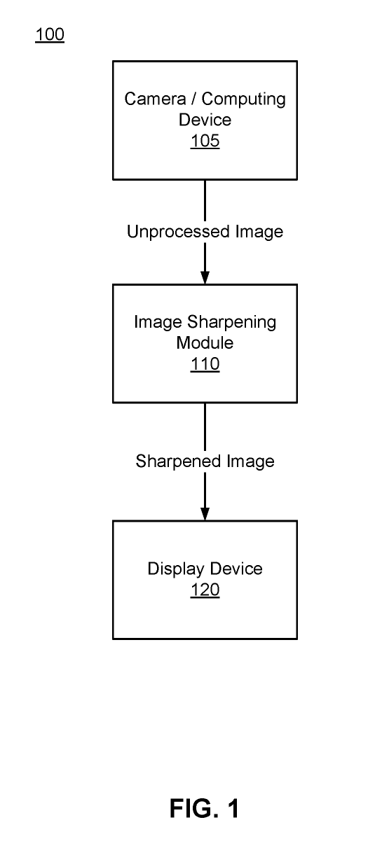

FIG. 1 illustrates an example environment 100 for image sharpening, according to an embodiment. As shown, the environment 100 may include a camera or a computing device 105, an image sharpening module 110 and a display device 120. A user can take pictures with a camera or a computing device 105. For example, a computing device 105 may be a desktop computer, a laptop computer, a tablet computer, a smart phone, or any other device coupled with a camera and having computing functionality and data communication capabilities.

The unprocessed images from the camera/computing device 105 may be sent to the image sharpening module 110. The image sharpening module 110 may apply a uniform image sharpening algorithm based on polar co-ordinates on the unprocessed image, e.g. raw image. The image sharpening algorithm corrects the focus and blurs in the image, which may result in a better quality and sharpened image. The sharpened image may be further processed and sent to a display device 120 for a user to view.

### Sharpening Algorithm Parameters and Matrices

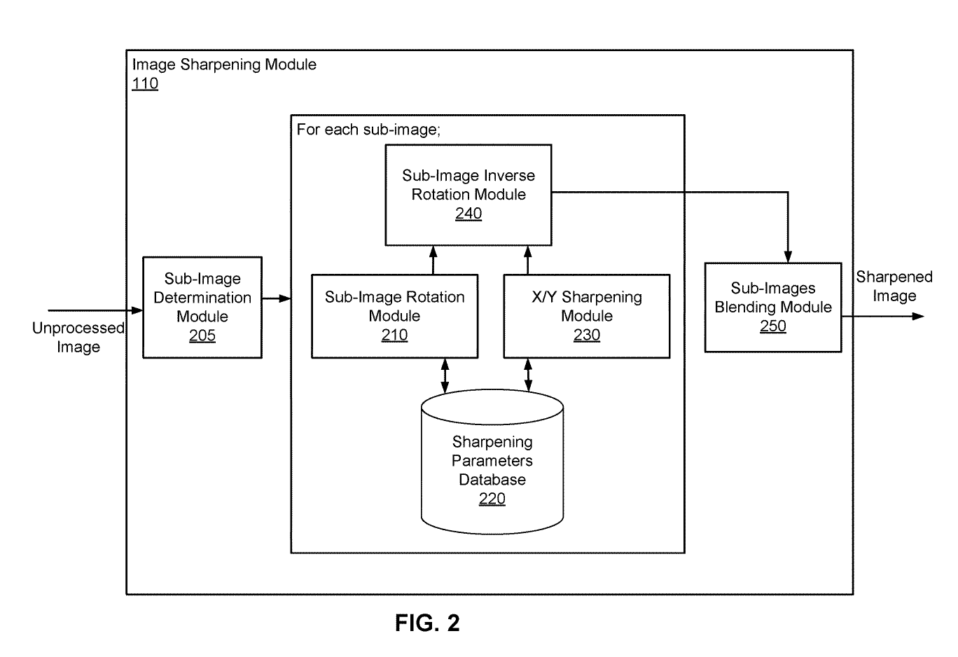

FIG. 2 illustrates the logical components of the image sharpening module 110, according to an example embodiment. The image sharpening module 110 may include a sub-image determination module 205, a sub-image rotation module 210, an X/Y sharpening module 230, a sharpening parameters database 220, a sub-image inverse rotation module 240, and a sub-images blending module 250.

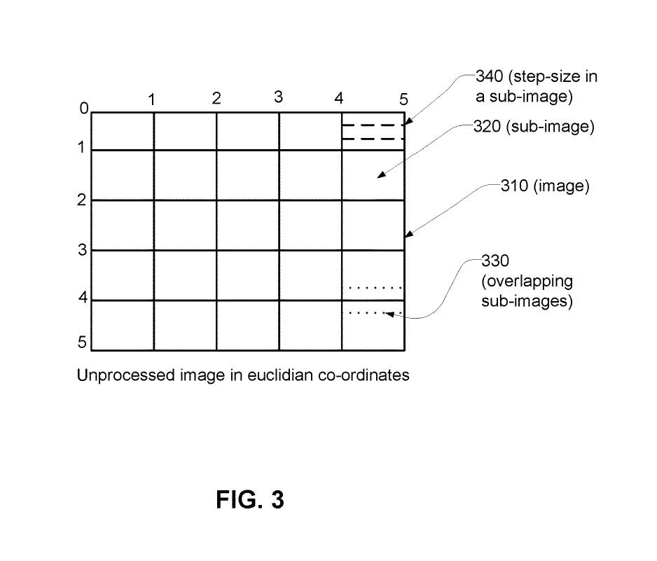

The sub-image determination module 205 may be configured to receive an unprocessed image represented in the Euclidian plane that includes an X-axis and Y-axis dimension, from camera or the computing device 105. The sub-image determination module 205 may be configured to split the image in to a number of sub-images. The number is configurable, for example, for an image size of 640 pixels by 480 pixels can be split into a number of sub-images of size 40 pixels by 30 pixels. FIG. 3 shows an example image 310 and sub-image 311 in the Euclidian co-ordinate system.

The image 310 can be divided into a number of sub-images 320, each sub-image represented by four (X-axis, Y-axis) co-ordinates. The sub-image 320 in FIG. 3 can be represented by co-ordinates (4, 0), (5, 0), (1, 5) and (1, 4).

Referring back to FIG. 2, further processing may be performed on each of the sub-images by the sub-image rotation module 210, the X/Y sharpening module 230 and the sub-image inverse rotation module 240. The sub-image rotation module 210 may rotate the sub-image at a specific rotation angle to align the image lines to a Euclidian pixel grid. Aligning an image to a pixel grid enables an object in an image to have its vertical and horizontal paths aligned to the pixel grid.

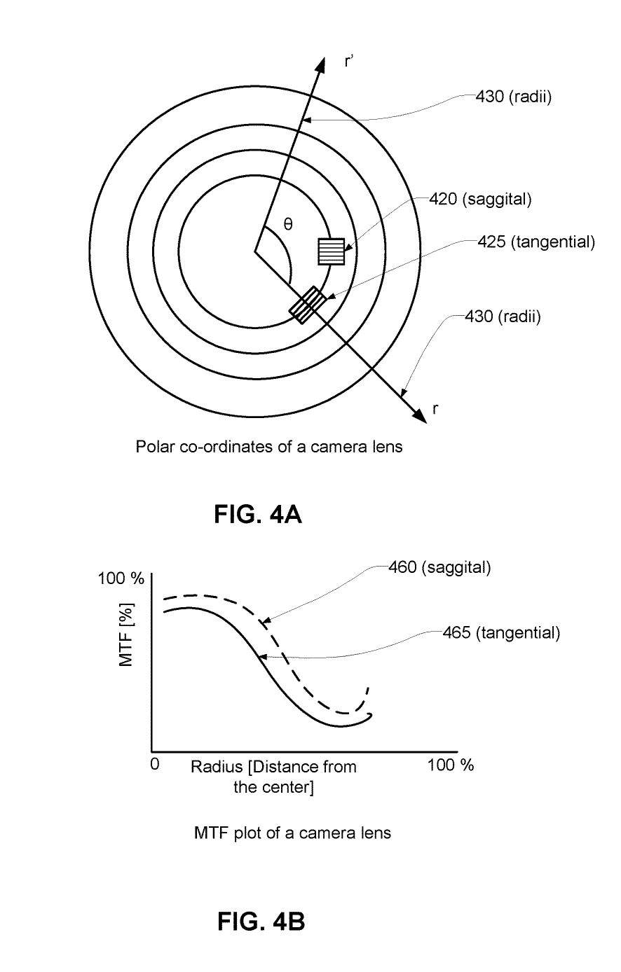

The X/Y sharpening module 230 may apply sharpening along the X-axis or Y-axis of the rotated image based on a sagittal or a tangential function of the image. The sharpening algorithm parameters include a sagittal function S(r) or a tangential function T(r) The sagittal function S(r) and tangential function T(r) are determined based on the modulation transfer function (MTF) of the camera lens. The MTF is a measure of the transfer of modulation from the subject to the image (i.e., a measure of the image quality of the lens). The image quality changes from the center of the lens to the edge of the lens. The change in the image quality is determined by a plot of the MTF values for the each radius for tangential and sagittal orientations. Examples of the tangential and sagittal orientations are illustrated in FIG. 4A and the MTF plot for a camera lens is illustrated in FIG. 4B.

The sharpening may be a function based on a radius for a sagittal or tangential portion of the image. Depending on the direction of the rotation angle, the sagittal or tangential portion is sharpened on the X-axis or Y-axis. The X′ sharpening applied to a sagittal portion S(r) may be S(y) or S(x), depending on the direction of the rotation angle. Similarly, the Y′ sharpening applied to a tangential portion T(r) may be T(y) or T(x).

For example, if a sagittal portion is rotated in a clockwise direction, a sharpening function (X′) is applied along the X-axis, if a sagittal portion is rotated in a counter clockwise direction, a sharpening function (X′) is applied along the Y-axis. Similarly, if a tangential portion is rotated clockwise, a sharpening function (Y′) is applied along the Y-axis and vice versa.

Once the rotated sub-image is sharpened, the sub-image inverse rotation module 240 may rotate the sharpened sub-image to the original orientation. In one example embodiment, the inverse rotation of the sub-image is done by rotating the sub-image by the specified rotation angle in a direction opposite to the original rotation. For example, if the sub-image was rotated at an angle of 40 degrees in the clockwise direction by the sub-image rotation module 210, the sub-image inverse rotation module 240 rotates the sub-image in a counter clockwise direction by 40 degrees. In another example embodiment the sub-image can be rotated in the same direction as the original rotation but by a different rotation angle. For example, if the sub-image was rotated at an angle of 40 degrees in the clockwise direction by the sub-image rotation module 210, the sub-image inverse rotation module 240 rotates the sub-image in a clockwise direction by 320 degrees to reach the original orientation of the sub-image.

The sharpened sub-images may be blended by the sub-images blending module 250 to reduce the discontinuities between the sub-images. In one example embodiment, the blending is done by applying an average function over two or more sub-images. The averaging function reduces the step discontinuities between sub-images. In another example embodiment, the blending is done by polynomial curve fitting. The polynomial curve fitting is the process of constructing a curve (i.e., a mathematical function) that has a best fit to a series of data points. The data points in this case are the step sizes (i.e., the sub-images or portions of sub-images or portions of sub-images that overlap one or more sub-images) that the image is split up into. The polynomial curve fitting is a computationally intensive method of blending the sub-images. FIG. 3 shows an example step size in a sub-image 340 and overlapping sub-images 330. The finer the step size, the better is the blending of the sharpened sub-images. Similarly, the overlapping portion of the sub-images reduces discontinuities in the sub-images.

FIG. 4A illustrates the polar co-ordinate plane of the camera lens, according to one example embodiment. The polar co-ordinate plane shows the different radii 430 of the camera lens. The longitudinal orientation of the stripes 425 toward the center is the sagittal component and the stripes perpendicular to the radii, i.e., tangential to the radii, is the tangential component 430 of the lens.

FIG. 4B illustrates a modulation transfer function plot for every radii of a camera lens, according to one example embodiment. The tangential plot 465 shows the changing MTF values corresponding to the radii of the lens. For example, for a radius value of 10% (i.e., at a distance of 10% from the center of the lens), the MTF value is higher, i.e., better image quality, for both the tangential 465 and sagittal 460 plots. The sagittal and tangential functions for the pixels of an image are determined based on this MTF plot. For example, for a radius of 10%, the sagittal function S(r)=S(10) has an MTF of approximately 90% and the sagittal function S(r)=S(70) has an MTF of approximately 30%. Similarly, tangential function T(r) is determined based on the tangential 465 plot of MTF for each radii of the lens. The MTF plots for the lens are stored in the sharpening parameters database 220. In an alternate embodiment, the sagittal and tangential functions for the different angles or different radii are stored in the sharpening parameters database 220 along with the MTF plots. The X/Y sharpening module 230 retrieves the MTF for the camera lens from the sharpening parameters database 220 and determines the values for the sagittal and tangential functions for a specific radius. Alternatively, the X/Y sharpening module 230 can retrieve the sagittal and tangential function for a specified radius.

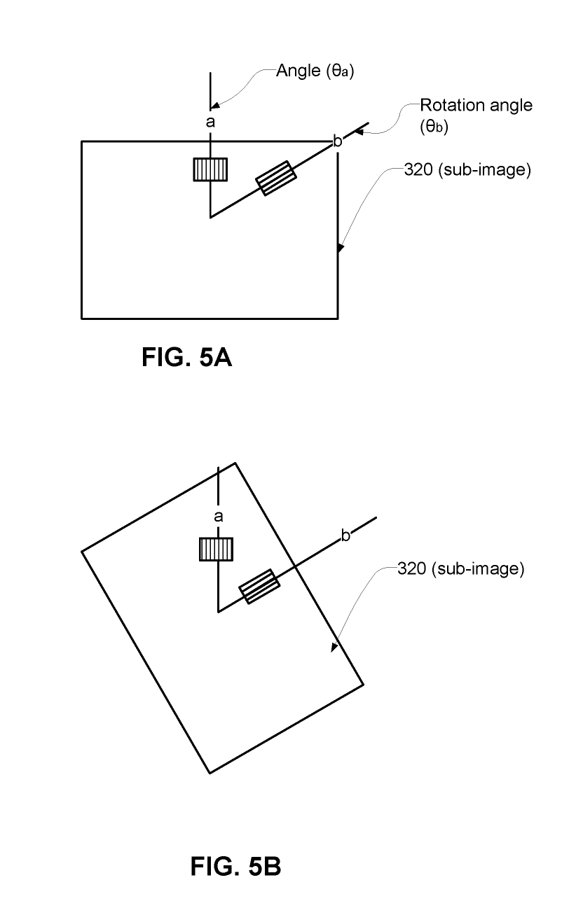

FIGS. 5A-5B illustrate an exemplary rotation of a sub-image based on a specific rotation angle, according to one example embodiment. The rotation of a sub-image is performed by the sub-image rotation module 230 and an inverse-rotation of the sub-image is performed by the sub-image inverse rotation module 240. The sub-image rotation module 230 receives a sub-image 320 that is oriented at angle θₐ at a radius “a”. The sub-image rotation module 230 rotates the sub-image to a specific rotation angle θ_{b} at a radius “b”. In the FIG. 5A, the radius a is the same as radius b. In another example embodiment, they can be different. FIG. 5B illustrates the rotated sub-image at the specified rotation angle θ_{b.}

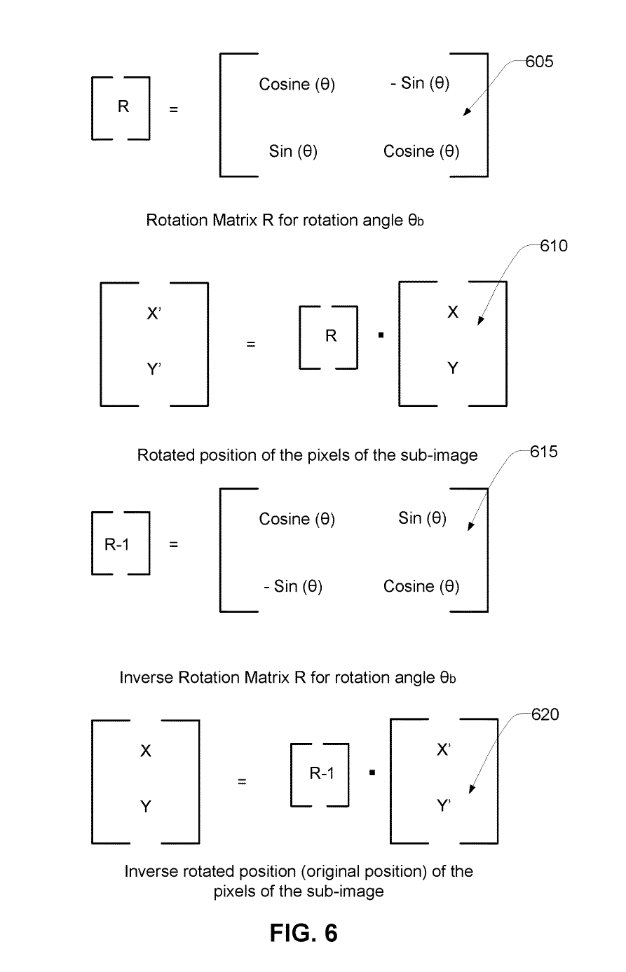

FIG. 6 illustrates an exemplary rotation matrix, sharpening matrix and an inverse rotation matrix according to one example embodiment. The rotation matrix R 605 is a standard rotation matrix that is used to perform rotation in the Euclidian space, based on an angular component θ. For example, a vector component of a point (X,Y) in the Euclidian space may be rotated about its origin by an angle θ by multiplying the vector component with the rotation matrix R 605 to obtain a rotated position 610 of the point (X′ Y′) as shown in FIG. 6.

FIG. 6 further illustrates an inverse rotation matrix 615 that is used to perform inverse rotation based on the angular component, for example, rotate the vector components of a point in the Euclidian space in a counter clockwise angular direction. The rotated pixels of a sub-image may be inverse rotated 620 to their original position by multiplying the vector component of the rotated pixel to an inverse rotation matrix 615.

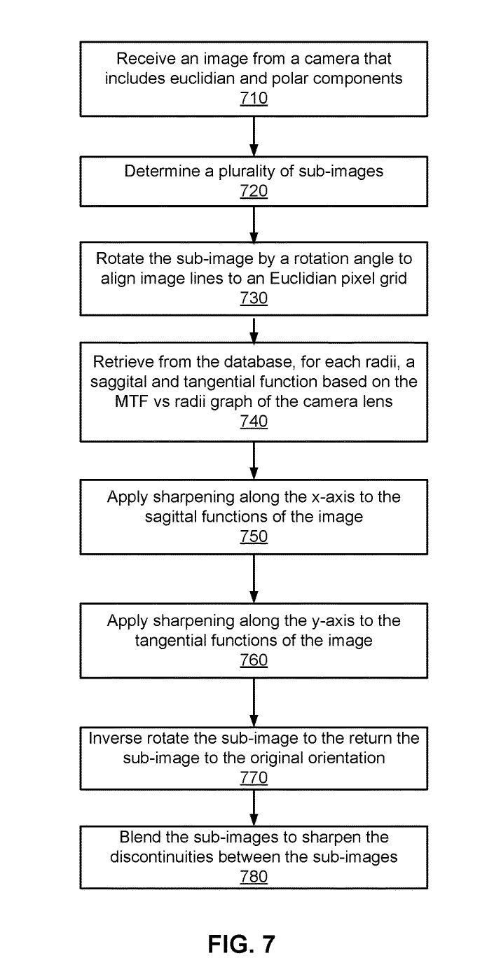

FIG. 7 illustrates a flowchart of an example method for sharpening an image based on polar co-ordinates, according to one embodiment. The image sharpening module 110 receives 710 an image from a camera system or a computing device that includes Euclidian and polar components. The polar components of the image are based on the architecture of the camera lens and include a radial component and a polar angle component. The image sharpening module 110 further determines 720 a plurality of sub-images based on the Euclidian dimensions of the image. The sub-image rotation module 210 rotates 730 each sub-image by a pre-determined specific rotation angle θ.

In one embodiment, each pixel (e.g., X, Y as illustrated in FIG. 6) or a set of pixels of the sub-image, are rotated based on a rotation matrix. A pixel is represented in the Euclidian plane by an X-position and a Y-position. An exemplary rotation matrix R is illustrated in FIG. 6. The elements of the matrix are circular functions on the rotation angle θ. The position of a pixel is represented in a vector 610 that includes the X-position and Y-position of the pixel. The rotation matrix R rotates the pixels or a set of pixels in the Euclidian plane in a counter-clockwise or a clockwise direction through the rotation angle θ about the center, performed by multiplying the rotation matrix with the pixel position vector 610.

The pixels or set of pixels of the rotated sub-image are further sharpened by the X-Y sub-image sharpening module 230. The sharpening is applied based on the sagittal and tangential functions of the sub-image pixels. The sagittal and tangential functions of a sub-image, for each radius are retrieved 730 from the sharpening parameters database 220. The sagittal and tangential functions are based on a modular transfer function plot (MTF) of the camera lens, the MTF representing the quality of image transferred from the subject to the image. The sagittal function S(r) represents the pixels that are at longitudinal orientation of the sub-image towards the radii and the tangential function T(r) represents the pixels that are at a perpendicular orientation to the radii, i.e., tangential to the radii.

A sharpening algorithm is applied to the sagittal and tangential functions of the pixels of the sub-image. Examples of sharpening algorithms include unsharp masking, edge enhancement, etc. An exemplary form of image sharpening involves a form of contrast. This is performed by finding the average color of the pixels around each pixel in a specific radius, and then contrasting that pixel from that average color. In one embodiment, the sagittal function of the set of pixels of the sub-image is sharpened 750 along the X-axis, i.e., in a direction opposite to the orientation of the sagittal component of the pixels. Similarly, the tangential function of the set of pixels of the sub-image is sharpened 760 along the Y-axis.

The application of the sharpening further depends on the rotation direction of the sub-image. For example, if the sub-image is rotated in a counter-clockwise direction, sharpening to the sagittal function of the pixels is applied in the Y-axis direction, i.e., S(r)=S(y), if the sub-image is rotated in a clockwise direction, the sharpening is applied in the X-axis direction, i.e. S(r)=S(x). Similarly, if the sub-image is rotated in a counter-clockwise direction, sharpening to the tangential function of the pixels is applied in the X-axis direction, i.e., T(r)=T(x), if the sub-image is rotated in a clockwise direction, the sharpening is applied in the Y-axis direction, i.e., T(r)=T(y).

The sharpened pixels of the sub-images are inverse rotated 770 to their original orientation by the sub-image inverse rotation module 240. An exemplary inverse rotation matrix R⁻¹ is illustrated in FIG. 6. The elements of the matrix are inverse circular functions of the corresponding elements of the rotation matrix for the rotation angle θ. The position of the rotated pixels is represented in a vector 620 that includes the X-position and Y-position of the rotated pixel. The inverse rotation matrix R⁻¹ rotates the pixels or a set of pixels in the Euclidian plane in a direction opposite to the original rotation (e.g. if the sub-image was originally rotated in a counter-clockwise direction, the inverse rotation is done in the clockwise direction) through the rotation angle θ about the center. This is performed by multiplying the inverse rotation matrix with the rotated pixel position vector 620.

The sharpened and inverse-rotated sub-images are blended 780 by the sub-images blending module 250. When the sub-images are stitched together, the stitched edges have discontinuities that may be visible in the image. To reduce these discontinuities a blending algorithm is applied to the each of the sub-images, or in a running window of sub-images. A running window of sub-images involves carrying forward a portion of blended sub-image to the next sub-image to ensure a smoother blend of sub-images. Exemplary blending algorithms include a point cloud mesh, polynomial webbing and other such algorithms.

### Computing Machine Architecture

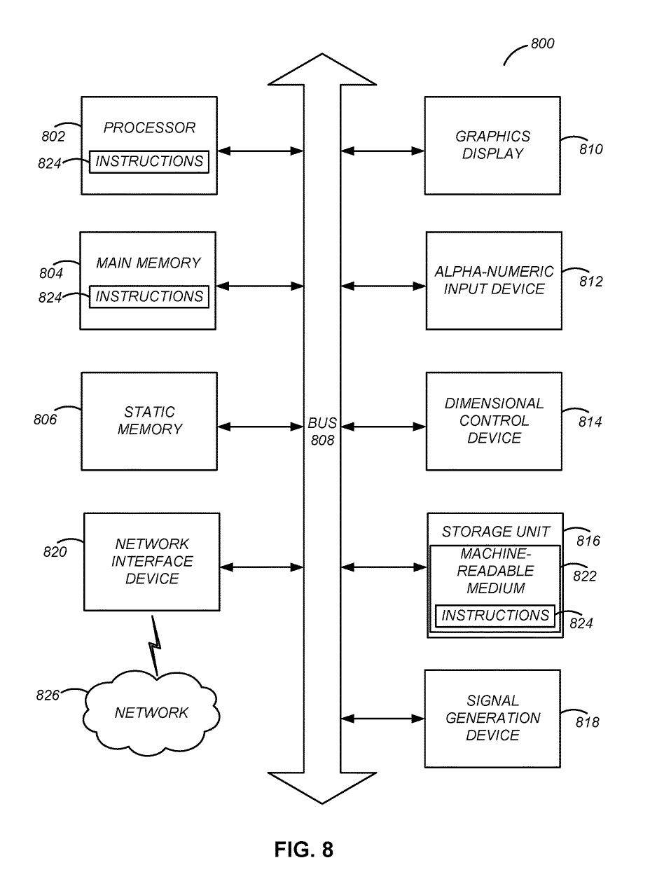

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein. For example, the computer system 800 can be used to operate the image sharpening module 110 and the processes described with respect to FIGS. 3-7. It is noted that not all the components of the computer system 800 described below may be needed to execute the processing described with FIGS. 3-7. For example, the computer system 800 may be the camera/computing device 105 with a processor and a memory.

Looking closer at the example computer system 800, it includes one or more processors 802 (generally processor 802) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media. It is noted that the instructions 824 can correspond to the processes of the image sharpening module 110 and its components as well as the processes of FIGS. 3-7.

### Additional Configuration Considerations

Example benefits and advantages of the disclosed configurations may include, for example, images that are sharpened in the Euclidian and polar dimensions based on the camera lens. The sharpening algorithm provides improved image qualities, i.e., removes the blur components of an image. Hence, photos and videos are of higher quality, e.g., greater sharpness. In addition, the sharpening algorithm may be used for noise removal in other applications, for example, X-ray imaging, machine vision imaging and the like.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate image sharpening processes and algorithms that sharpen an image in the Euclidian and polar dimensions of the camera lens from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for sharpening images from a camera, the method comprising:
receiving an image from a camera, including Euclidian plane components comprising of dimensional components and polar components comprising of radii components and angular components;
determining a plurality of sub-images of the received image based on the Euclidian plane components;
receiving a rotation angular component for aligning the sub-image;
rotating a plurality of pixels of the sub-image by multiplying a pixel vector with a rotation matrix that is based on the rotation angular component;
receiving, based on the polar components of a lens of the camera, for each radii of the sub-image, a sagittal function and a tangential function that is determined based on a modulation transfer function of the lens, the modulation transfer function comprising a function that determines the performance of the lens for a plurality of radii of the lens;
applying a sharpening function to sharpen the sagittal function of the plurality of pixels along the dimensional components of the sub-image, wherein the sharpening function is based on a radii and the rotation angular component for the sub-image;
applying a sharpening function to sharpen the tangential function of the plurality of pixels along the dimensional components of the sub-image, wherein the sharpening function is based on a radii and the rotation angular component for the sub-image; receiving an inverse rotation angular component to revert the orientation of the sub-image;
inverse rotating a plurality of pixels of the sub-image by multiplying a rotated pixel vector with an inverse rotation matrix that is based on the inverse rotation angular component; and
blending the sub-images to sharpen the discontinuities at the edges of the sub-images.

2. The method of claim 1, wherein the elements of the rotation matrix are circular functions based the received rotation angular component.

3. The method of claim 1, wherein the elements of the inverse rotation matrix are inverse circular functions based the received inverse rotation angular component.

4. The method of claim 3, wherein the elements of the inverse rotation matrix are inverse functions of the elements of the rotation matrix.

5. The method of claim 1, wherein the sagittal radial function is the modulation transfer function of a sagittal component for a subject radius of the camera lens, wherein the sagittal component is defined as the image component that is parallel in orientation to the radius.

6. The method of claim 1, wherein the tangential radial function is the modulation transfer function of a tangential component for a subject radius of the lens, wherein the tangential component is defined as the image component that is at least one of a perpendicular or tangential, in orientation to the radius.

7. The method of claim 1, wherein the sharpening function for the sagittal function is further based on a direction of rotation of the plurality of pixels of the sub-image.

8. The method of claim 1, wherein the sharpening function for the tangential function is further based on a direction of rotation of the plurality of pixels of the sub-image.

9. The method of claim 1, wherein determining a plurality of sub-images further comprises determining step-size of each sub-image.

10. A computer readable medium configured to store instructions, the instructions when executed by a processor cause the processor to:
receive an image from a camera, including Euclidian plane components comprising of dimensional components and polar components comprising of radii components and angular components;
determine a plurality of sub-images of the received image based on the Euclidian plane components;
receive a rotation angular component for aligning the sub-image;
rotate a plurality of pixels of the sub-image by multiplying a pixel vector with a rotation matrix that is based on the rotation angular component;
receive, based on the polar components of a lens of the camera, for each radii of the sub-image, a sagittal function and a tangential function that is determined based on a modulation transfer function of the lens, the modulation transfer function comprising a function that determines the performance of the lens for a plurality of radii of the lens;
apply a sharpening function to sharpen the sagittal function of the plurality of pixels along the dimensional components of the sub-image, wherein the sharpening function is based on a radii and the rotation angular component for the sub-image;
apply a sharpening function to sharpen the tangential function of the plurality of pixels along the dimensional components of the sub-image, wherein the sharpening function is based on a radii and the rotation angular component for the sub-image; receiving an inverse rotation angular component for reverting the orientation of the sub-image;
inverse rotate a plurality of pixels of the sub-image by multiplying a rotated pixel vector with an inverse rotation matrix that is based on the inverse rotation angular component; and
blend the sub-images to sharpen the discontinuities at the edges of the sub-images.

11. The computer readable storage medium of claim 10, wherein the elements of the rotation matrix are circular functions based the received rotation angular component.

12. The computer readable storage medium of claim 10, wherein the elements of the inverse rotation matrix are inverse circular functions based the received inverse rotation angular component.

13. The computer readable storage medium of claim 12, wherein the elements of the inverse rotation matrix are inverse functions of the elements of the rotation matrix.

14. The computer readable storage medium of claim 10, wherein the sagittal radial function is the modulation transfer function of a sagittal component for a subject radius of the camera lens, wherein the sagittal component is defined as the image component that is parallel in orientation to the radius.

15. The computer readable storage medium of claim 10, wherein the tangential radial function is the modulation transfer function of a tangential component for a subject radius of the lens, wherein the tangential component is defined as the image component that is at least one of a perpendicular or tangential, in orientation to the radius.

16. The computer readable storage medium of claim 10, wherein the sharpening function for the sagittal function is further based on a direction of rotation of the plurality of pixels of the sub-image.

17. The computer readable storage medium of claim 10, wherein the sharpening function for the tangential function is further based on a direction of rotation of the plurality of pixels of the sub-image.

18. The computer readable storage medium of claim 10, wherein determining a plurality of sub-images further comprises determining step-size of each sub-image.

19. A computer program product for image sharpening, the computer program product comprising a computer-readable storage medium containing computer program code that comprises:
an image sharpening module configured to receive an image from a camera, including Euclidian plane components comprising of dimensional components and polar components comprising of radii components and angular components;
a sub-image determination module configured to determine a plurality of sub-images of the received image based on the Euclidian plane components;
a sub-image rotation module configured to rotate a plurality of pixels of the sub-image by multiplying a pixel vector with a rotation matrix that is based on a rotation angular component for aligning the sub-image;
an X-Y sharpening module configured to apply a sharpening function to at least one of a sagittal function or a tangential function of the plurality of pixels along the dimensional components of the sub-image;
a sub-image inverse rotation module configured to inverse rotate a plurality of pixels of the sub-image by multiplying a rotated pixel vector with an inverse rotation matrix that is based on the inverse rotation angular component; and
a sub-image blending module configured to blend the sub-images to sharpen the discontinuities at the edges of the sub-images.

20. The computer program product of claim 19, wherein the program code for the X-Y sharpening module configured to apply the sharpening function for the sagittal function is further configured to be based on a direction of rotation of the plurality of pixels of the sub-image.

21. The computer program product of claim 19, wherein the program code for the X-Y sharpening module configured to apply the sharpening function for the tangential function is further configured to be based on a direction of rotation of the plurality of pixels of the sub-image.

22. The computer program product of claim 19, wherein the program code for the sub-image determination module to determine a plurality of sub-images further is configured to determine step-size of each sub-image.
